(19) United States
(12) Patent Application Publication
(10) Pub. No.: US 2025/0253804 A1
(43) Pub. Date: Aug. 7, 2025

(54) Ultrasonic Excitation of Solar Panels for Onsite Dry Cleaning

(71) Applicant: Cresktek, Inc., Ewing Township, NJ (US)

(72) Inventors: Semir Bajric, Grub SG (CH); Jurgen Kising, Kreuzlingen (CH); Brian Kivisto, Panama City Beach, FL (US)

(21) Appl. No.: 19/042,475

(22) Filed: Jan. 31, 2025

Related U.S. Application Data
(60) Provisional application No. 63/627,904, filed on Feb. 1, 2024.

(51) Int. Cl. H02S 40/10; B08B 7/02

(52) U.S. Cl. CPC H02S 40/10; B08B 7/028

(57) ABSTRACT

A self-cleaning solar panel system and method for achieving the same, utilizing ultrasonic waves and excitation frequencies. The system comprises a series of solar panels, each equipped with an ultrasonic converter, curved waveguide, and an ultrasonic disc affixed directly to a surface of the solar panel. The ultrasonic converter can be powered by a generator such that it delivers variable excitation frequencies and a pulsing ultrasonic wave. The solar panels are angled at a fixed slope that is optimized to dislodge and remove dust and debris from the surface of the solar panels with the excitation frequency, without significantly reducing the efficiency of the solar panels.

### RELATED APPLICATIONS

The present disclosure claims to the benefit of U.S. Provisional Application Ser. No. 63/627,904, filed Feb. 1, 2024, which is hereby fully incorporated by reference in its entirety.

### TECHNICAL FIELD

The present invention generally relates to a solar panel cleaning system, more specifically a self-cleaning ultrasonic solar panel system.

### BACKGROUND

Renewal energy sources have become increasingly popular in the 21st century. Solar “farms” are one such energy source, where dozens or hundreds of solar panels are deployed in a high sun exposure area. Throughout their use, solar panels can accumulate debris and dust, which decreases the functionality of the solar panels and the panels must periodically be cleaned off. The accumulation can result in efficiency losses of up to 30% or more. To remove the dust and debris by gravitational force alone, the solar panel may need to be angled at a slope of 40° to 60°, which causes further efficiency losses because steep angles reduce the solar cells' exposure to solar rays (which are typically optically directed at approximately a 90° angle to the solar panel face). The need for effective cleaning solutions that does not require angling the solar panels at a steep slope can be critical to maintain optimal performance.

Solar “farms” have their own set of particular challenges when it comes to cleaning the panels deployed. First, the sheer human power required to clean dozens or hundreds of panels is costly and the manual process is slow. Second, many solar farms are in remote locations or difficult to traverse, making it challenging for humans to clean the individual solar panels. There is a need for a system and method of “self-cleaning” solar panels.

One potential solution is ultrasonic excitation, achieved through attaching a piezo disc to a solar panel's glass surface. However, this method of ultrasonic excitation can be inadequate to effectively clean solar panels. Dust and debris accumulate at the nodes of vibration patterns and the vibration amplitude may not be sufficient to generate enough surface friction reduction for a beneficial cleaning effect. Further, the majority of solar panels utilized in solar farms are protected by a layer of glass paneling, which are in fixed contact with the solar panel surfaces. This extra protection can necessitate a higher level of excitations amplitudes than conventional ultrasonic cleaning heads typically provide.

There is a demonstrated need for a self-cleaning solar panel system and method that improves on current ultrasonic vibration techniques.

### SUMMARY

The present application discloses a self-cleaning solar panel system and method that in large part solves the problems outlined above. The self-cleaning solar panel system hereof includes at least one solar panel, at least one ultrasonic disc affixed to the at least one solar panel, at least one curved or straight waveguide affixed to the at least one ultrasonic disc, and at least one ultrasonic converter affixed to the at least one curved waveguide. The system further comprises a generator configured to power the ultrasonic converters and, in some embodiments, may comprise a splitter such that the generator can power more than one ultrasonic converter. In some embodiments, the system can further comprise a vibration amplitude inverter configured to be affixed between the ultrasonic sonic converter and the waveguide.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1A is a side perspective view of a self-cleaning solar panel system;

FIG. 1B is a back perspective view of a self-cleaning solar panel system;

FIG. 2 is a perspective view of a self-cleaning solar panel system comprising multiple solar panels; and

FIG. 3 is a perspective view of an ultrasonic excitation device.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Embodiments disclosed herein can include a system and method for self-cleaning solar panels. The system for self-cleaning solar panels can comprise at least one solar panel, at least one ultrasonic disc, at least one curved waveguide, at least one ultrasonic converter, and a generator. The solar panel can further comprise a protective glass cover affixed directly to a surface of both a front side and a back side of the solar panel.

The solar panel can be affixed to a base configured to install and secure the solar panel to the ground. The base can comprise an articulating hinge configured to angel the solar panel to the optimum angle. The optimum angle will have the highest power output while still having a sufficient cleaning effect. The operating position is contemplated to be 90° relative to the positive of the sun, but it is contemplated other angles may be more suitable in different environments. In some embodiments or environments, it is contemplated that the articulating hinge can be configured to angle the solar panel at a greater or less slope depending on thew mean position of the sun. For example, the articulating hinge can be configured to angle the solar panel at a slope between 15° and 25°, relative to the mean position of the sun.

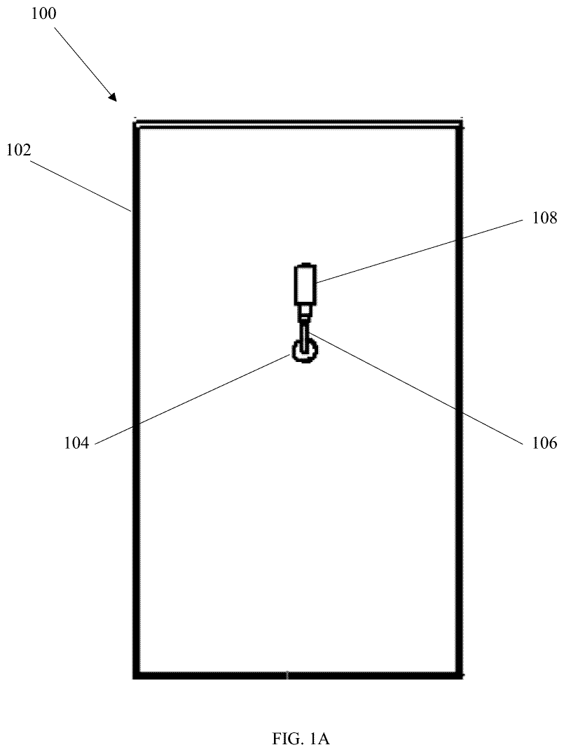

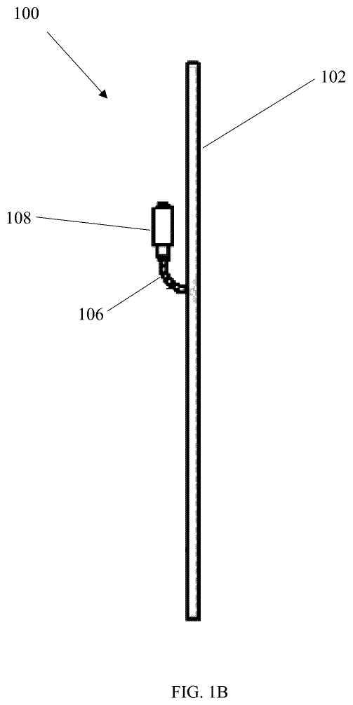

In embodiments, each individual ultrasonic disc is affixed to an individual solar panel within a given system embodiment and can be affixed directly to the protective glass cover. The ultrasonic disc can be affixed to the front or the back of the solar panel. In the exemplary embodiment of a self-cleaning solar panel system 100 depicted in FIGS. 1A and 1B, an ultrasonic disc 104 is affixed to a back surface of a solar panel 102. Affixing the ultrasonic disc to the back surface of the solar panel can be advantageous because it does not interrupt exposure of any of the solar cells present on the front surface of the solar panel.

The ultrasonic disc 104 can be functionally connected to an ultrasonic converter 108 via a waveguide 106. The waveguide 106 can be curved or straight. The waveguide 106 can have curved angles between 0° and 90°, relative to the ultrasonic disc 104. When connected, the ultrasonic converter 108 is configured to deliver an excitation frequency and a pulsing ultrasonic wave. The excitation frequency can be varied throughout the duration of the delivery of the excitation frequency. It is contemplated that the excitation frequency can be in the range of 30 KHz to 40 KHz for 35 KHz generators. Other excitation frequencies can be utilized to suit the environment or type of dust and debris that a particular solar panel system is exposed to.

In some embodiments, the ultrasonic converter can be functionally connected to multiple ultrasonic discs. In such embodiments, the ultrasonic converter can deliver excitation frequencies to each of the multiple ultrasonic discs via multiple waveguides that can be affixed to a bar affixed to the ultrasonic converter. The multiple waveguides can be affixed to the bar via welding or other suitable methods. The ultrasonic converter can be powered by a 20 KHz generator, and the ultrasonic converter can deliver sufficient excitation frequencies to the multiple ultrasonic discs.

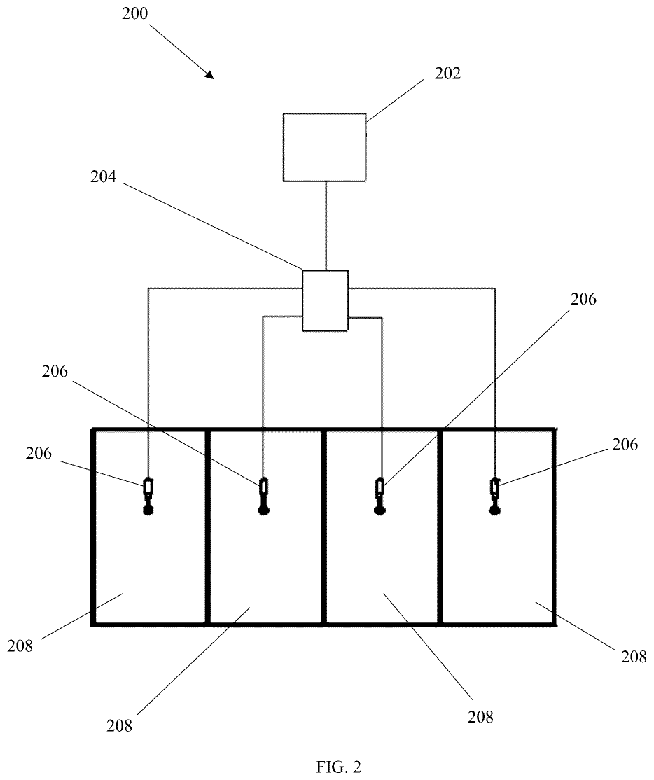

Referring now to FIG. 2, embodiments of the self-cleaning solar panel system 200 can be powered by a generator 202. The generator 202 is configured to deliver power in the range of 30 KHz to 40 KHz. It is contemplated that more or less powerful generators may be utilized to power various embodiments of the system based on the number of solar panels in a given system, the size of the solar panels in a given system, the level of excitation frequency required for a given system, and the angulation required for a given system. In the exemplary system, the generator 202 is electrically connected to a series of ultrasonic converters 206 via a splitter box 204. The ultrasonic converters 206 are affixed to a series of solar panels 208.

The splitter box 204 can be configured such that it delivers power to only one of the ultrasonic converters 206. In an exemplary cleaning cycle, the generator 202 delivers power to the splitter box 204, and the splitter box 204 directs power to the ultrasonic converter 206 of the corresponding solar panel 208. The powered ultrasonic converter 206 begins delivering an excitation frequency and a pulsing ultrasonic wave, which are delivered to the solar panel 208 via an ultrasonic disc 210. The excitation frequency and the pulsing ultrasonic wave agitate dust and debris from the surface of the solar panel 208, and the angulation of the solar panel 208 causes the agitated dust and debris to slide and fall off the surface of the solar panel 208.

It is contemplated that the ultrasonic converter can deliver the excitation frequency and pulsing ultrasonic wave for some predetermined amount of time, such as one minute. In other embodiments, it is contemplated that the system may be equipped with sensors that detect when all the dirt and debris has been removed from the surface of the solar panel 208, and once such an instance is detected, the system ceases delivery of power to that particular ultrasonic converter 206. The splitter box 204 then begins directing power to another ultrasonic converter 206 in the system 200. The process is then repeated for every solar panel in the system.

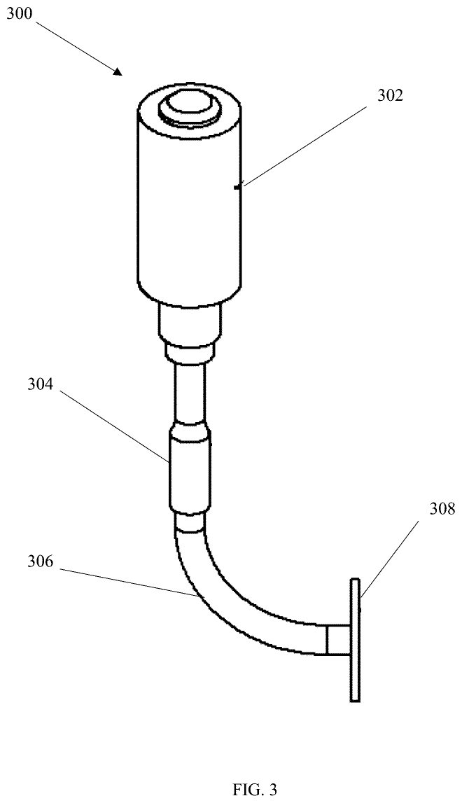

In some embodiments, it may be desirable to further equip the system with a vibration amplitude inverter, as depicted in FIG. 3. An exemplary ultrasonic delivery system 300 can comprise an ultrasonic converter 302, a vibration amplitude inverter 304, a curved waveguide 306, and an ultrasonic disc 308. The ultrasonic converter 302 is affixed to the vibration amplitude inverter 304, which in turn is affixed to the curved waveguide 306, which in turn is affixed to the ultrasonic disc 308. The vibration amplitude inverter 304 is configured to increase the vibration force delivered to the ultrasonic disc 308 by the ultrasonic converter 302. Increasing the vibration force can improve the efficiency of dust and debris removal throughout the course of the delivery of an excitation frequency and a pulsing ultrasonic wave. In embodiments that include the vibration amplitude inverter 308, the structure of the solar panel the ultrasonic delivery system 300 is affixed to can be configured to damp the vibration amplitude.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A self-cleaning solar panel system, the system comprising:
at least one solar panel, wherein the solar panel is angled at a slope;
at least one ultrasonic disc;
at least one ultrasonic converter;
at least one waveguide; and
a generator.

2. The self-cleaning solar panel system of claim 1, the system further comprising a vibration amplitude inverter.

3. The self-cleaning solar panel system of claim 2, wherein the vibration amplitude inverter is affixed to the system between the ultrasonic converter and the curved waveguide.

4. The self-cleaning solar panel system of claim 1, wherein the waveguide is curved or straight.

5. The self-cleaning solar panel system of claim 1, wherein the slope of the solar panel is between 70° and 110° relative to a mean angle of the sun.

6. The self-cleaning solar panel system of claim 1, wherein the ultrasonic converter and the ultrasonic disc are functionally connected via the waveguide.

7. The self-cleaning solar panel system of claim 1, the system further comprising a splitter box configured to electrically connect the generator to a plurality of solar panels and further configured to switch the flow of power from the generator between each of the solar panels.

8. The self-cleaning solar panel system of claim 1, wherein the ultrasonic converter and the ultrasonic disc are configured to deliver an excitation frequency that varies throughout delivery of the excitation frequency.

9. The self-cleaning solar panel system of claim 1, wherein the ultrasonic converter and the ultrasonic disc are configured to deliver a pulsing ultrasonic wave.

10. The self-cleaning solar panel system of claim 1, wherein the ultrasonic disc is affixed to a front or a back surface of the at least one solar panel.

11. The self-cleaning solar panel system of claim 1, wherein the ultrasonic converter is functionally connected to more than one ultrasonic disc such that the ultrasonic converter can deliver excitation frequency and ultrasonic waves to more than one solar panel.

12. A method for self-cleaning solar panels, the method comprising:
delivering power to an ultrasonic converter, wherein the ultrasonic converter is functionally connected to an ultrasonic disc affixed to a surface of a solar panel, wherein the solar panel is angled at a slope;
delivering an excitation frequency and a pulsing ultrasonic wave to the ultrasonic disc; and
ceasing delivery of the excitation frequency and the pulsing ultrasonic wave to the ultrasonic disc.

13. The method for self-cleaning solar panels of claim 11, wherein the at least one ultrasonic converter is electrically connected to a generator via a splitter box configured to direct power to at least a second ultrasonic converter affixed to a second solar panel.

14. The method for self-cleaning solar panels of claim 13, the method further comprising directing power to the second ultrasonic converter, wherein the second ultrasonic converter is affixed to a second ultrasonic disc and the second ultrasonic disc is affixed to a surface of the second solar panel.

15. The method for self-cleaning solar panels of claim 11, wherein the ultrasonic disc is affixed to a front surface or a back surface of the solar panel.

16. The method for self-cleaning solar panels of claim 11, wherein the delivery of the excitation frequency and the pulsing ultrasonic wave is ceased after one minute.

17. The method for self-cleaning solar panels of claim 11, wherein the ultrasonic converter is connected to the ultrasonic disc via a curved or straight waveguide.

18. The method for self-cleaning solar panels of claim 11, wherein a vibration amplitude inverter is affixed between the ultrasonic converter and the ultrasonic disc.

19. The method for self-cleaning solar panels, wherein the slope of the solar panel is between 70° and 110° relative to a mean angle of the sun.

20. A maintenance-free solar panel, the solar panel comprising:
a front surface, wherein the solar panel is angled at a slope such that the front surface is between 80° and 100° relative to a mean angle of the sun;
an ultrasonic disc affixed to a back surface of the solar panel; and
an ultrasonic delivery system affixed to the ultrasonic disc, wherein the ultrasonic delivery system comprises an ultrasonic converter configured to be powered by a generator and configured to deliver an excitation frequency and a pulsing ultrasonic wave, a wave guide configured to direct the excitation frequency and pulsing ultrasonic wave to the ultrasonic disc;
wherein the excitation frequency and the pulsing ultrasonic wave are configured to dislodge dust and debris from the front surface such that the dust and debris slide off the front surface of the solar panel.
